(19) United States
(12) Patent Application Publication
(10) Pub. No.: US 2003/0177377 A1
(43) Pub. Date: Sep. 18, 2003

(54) Protecting computer software

(76) Inventor: John Aram Safa, Nottingham (GB)

Correspondence Address: SMITH-HILL AND BEDELL, 12670 N W BARNES ROAD, SUITE 104, PORTLAND, OR, 97229

(21) Appl. No.: 10/382,292

(22) Filed: Mar. 4, 2003

(30) Foreign Application Priority Data
Mar. 5, 2002 (GB) 0205047.4

(51) Int. Cl. H04L 9/32

(52) U.S. Cl. 713/189

(57) ABSTRACT

Software is protected by providing an incomplete copy for loading into RAM 30. One or more blocks of code 32 are missing. The choice and location of the missing code 32 is preferably substantially random. Thus, the RAM portion 30 contains an incomplete copy of the protected software, lacking additional code to be executable.

The code which is missing at 32 is located elsewhere, indicated at (36), and maybe within or external to the computer 10. A control routine 34 is operable to retrieve the missing code 32 from the location 36 when the protected software is to be executed, and to incorporate the additional code into the protected software at 32, to render the protected software fully executable.

The present invention relates to the protection of computer software and in particular, to the protection of software against unauthorised use.

Software which is provided on a commercial basis is commonly licensed to a particular user or group of users in return for a fee, which may be a single payment for indefinite use, or a payment allowing the software to be used for a fixed period of time, or on a fixed number of occasions. Much software can readily be copied by potential users who have not been authorised in this manner, thereby depriving the software supplier of legitimate revenue. Proposals have previously been made for incorporating security arrangements within software, for example to check licence details before allowing the software to be executed. These proposals have not been entirely successful. In particular, there is a significant commercial incentive for others to write additional software which causes the security checks to be identified and disabled or circumvented. Once the security incorporated in a particular software product has been successfully analysed and circumvented in this way, the additional software is likely to provide a generic solution to the security, allowing any unauthorised user to be provided with a fully executable copy of the proprietary software.

In accordance with the present invention, there is provided a method of protecting computer software against unauthorised use, in which a user machine is provided with an incomplete copy of the software, the incomplete copy lacking additional code to be executable, there being control means operable to retrieve the additional code when the protected software is to be executed, and to incorporate the additional code into the protected software to render the protected software executable.

The incomplete copy and the additional code may be provided by operating on a complete copy of the software to remove a portion of the code contained therein, the removed portion forming the additional code. One or more locations within the complete copy are preferably selected on each occasion that a copy of the software is to be protected, the additional code being removed from the selected location or locations. The selection of the or a location is preferably made in accordance with a selection algorithm. The selection may be substantially random.

Preferably the control means is incorporated into the incomplete copy to be operable when the protected software is to be executed.

The incomplete copy is preferably stored in auxiliary memory of a machine on which the protected software is to be executed, and is loaded to main memory on each occasion the protected software is to be executed, the additional code being retrieved on each occasion.

Preferably the additional code is incorporated into a process operable to execute, when called by the control means, to reinstate the additional code in the incomplete copy. The process may be executable on the same machine on which the protected software is to be executed.

Alternatively, the additional code may be stored, prior to retrieval, on a machine other than the machine on which the protected software is to be executed, there being a communication link available between the machines, for transmission of the additional code. The communication link may be provided by a wireless mobile communication network.

Preferably, retrieval of the additional code is prevented unless authorised. Authorisation means is preferably operable to determine if the retrieval is authorised. The authorisation means may be operable to effect a financial transaction required for authorisation to be given, or to ascertain whether or not the transaction has been effected. The authorisation means is preferably incorporated within the control means.

The invention also provides an incomplete software copy, and additional code, the copy and the code together forming software protected in accordance with the method set out above.

The present invention also provides an arrangement operable to protect computer software against unauthorised use, and including an incomplete copy of the software for provision to a user machine, the incomplete copy lacking additional code to be executable, and control means operable to retrieve the additional code when the protected software is to be executed, and to incorporate the additional code into the protected software to render the protected software executable.

Preferably the control means is incorporated into the incomplete copy to be operable when the protected software is to be executed.

Preferably the arrangement further comprises a process operable to execute, when called by the control means, to reinstate the additional code in the incomplete copy. The process may be executable on the same machine on which the protected software is to be executed.

Alternatively, the arrangement may include a machine other than the machine on which the protected software is to be executed, there being a communication link available between the machines, for transmission of the additional code. The communication link may be provided by a wireless mobile communication network.

Preferably, the other machine is operable to prevent retrieval of the additional code unless authorised. Authorisation means is preferably operable to determine if the retrieval is authorised. The authorisation means may be operable to effect a financial transaction required for authorisation to be given, or to ascertain whether or not the transaction has been effected. The authorisation means is preferably incorporated within the other machine.

The invention also provides computer apparatus operable to provide an arrangement as defined above.

The invention also provides computer software which, when installed on a computer system, is operable to provide a software protection arrangement as defined above.

The invention also provides a carrier medium carrying computer software as defined above. The carrier medium may be a memory device. Alternatively, the carrier medium may be transmission medium, the software being carried by a signal propagating on the transmission medium.

The invention also provides a signal propagating on a transmission medium, the signal carrying additional code for use in an arrangement as defined above.

The present invention also provides a method of protecting computer software against unauthorised use, in which an incomplete copy of the software is provided, the incomplete copy lacking additional code to be executable, and additional code is provided for retrieval when the protected software is to be executed, the additional code being incorporated into the protected software to render the protected software executable.

The incomplete copy and the additional code may be provided by operating on a complete copy of the software to remove a portion of the code contained therein, the removed portion forming the additional code. One or more locations within the complete copy are preferably selected on each occasion that a copy of the software is to be protected, the additional code being removed from the selected location or locations. The selection of the or a location is preferably made in accordance with a selection algorithm. The selection may be substantially random.

Preferably, control means operable to retrieve the additional code is incorporated into the incomplete copy to be operable when the protected software is to be executed.

Preferably the additional code is incorporated into a process operable to execute, when called by the control means, to reinstate the additional code in the incomplete copy. The process may be executable on the same machine on which the protected software is to be executed.

Alternatively, the additional code may be stored, prior to retrieval, on a machine other than the machine on which the protected software is to be executed, there being a communication link available between the machines, for transmission of the additional code. The communication link may be provided by a wireless mobile communication network.

Preferably, retrieval of the additional code is prevented unless authorised. Authorisation means is preferably operable to determine if the retrieval is authorised. The authorisation means may be operable to effect a financial transaction required for authorisation to be given, or to ascertain whether or not the transaction has been effected. The authorisation means is preferably incorporated within the control means.

The invention also provides an arrangement for protecting computer software against unauthorised use, the arrangement including first means operable to provide an incomplete copy of the software, the incomplete copy lacking additional code to be executable, and there being control means operable to retrieve the additional code when the protected software is to be executed, and to incorporate the additional code into the protected software to render the protected software executable.

The first means may be operable on a complete copy of the software to remove a portion of the code contained therein, the removed portion forming the additional code. The first means preferably selects one or more locations within the complete copy on each occasion that a copy of the software is to be protected, the additional code being removed from the selected location or locations. The selection of the or a location is preferably made in accordance with a selection algorithm. The selection may be substantially random.

Preferably the control means is incorporated into the incomplete copy to be operable when the protected software is to be executed.

Preferably the additional code is incorporated into a process operable to execute, when called by the control means, to reinstate the additional code in the incomplete copy. The process may be executable on the same machine on which the protected software is to be executed.

Alternatively, the arrangement may include a machine other than the machine on which the protected software is to be executed, and on which the additional code may be stored, prior to retrieval, there being a communication link available between the machines, for transmission of the additional code. The communication link may be provided by a wireless mobile communication network.

Preferably, said other machine prevents retrieval of the additional code unless authorised. Authorisation means is preferably operable to determine if the retrieval is authorised. The authorisation means may be operable to effect a financial transaction required for authorisation to be given, or to ascertain whether or not the transaction has been effected.

The invention also provides a method of providing computer software for a user, in which a user machine is provided with an incomplete copy of the software, the incomplete copy lacking additional code to be executable, and the additional code is made available for retrieval when the protected software is to be executed and an authorisation procedure has been completed, the additional code being incorporated into the protected software to render the protected software executable.

The additional code may be stored, prior to retrieval, on a machine other than the machine on which the protected software is to be executed, there being a communication link available between the machines, for transmission of the additional code. The communication link may be provided by a wireless mobile communication network.

Authorisation means is preferably operable to determine if the retrieval is authorised. The authorisation means may be operable to effect a financial transaction required for authorisation to be given, or to ascertain whether or not the transaction has been effected. The authorisation means is preferably incorporated within the control means.

Various arrangements for implementing the present invention will now be described in more detail, by way of example only, and with reference to the accompanying drawings, in which:

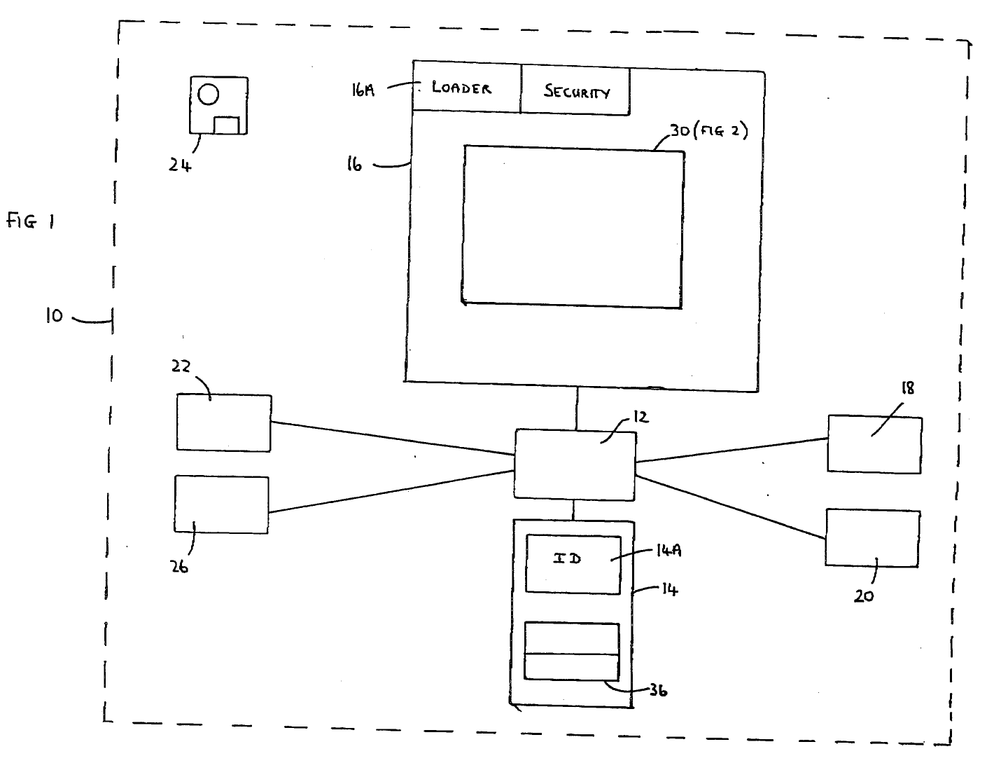

FIG. 1 is a simplified schematic diagram of a computer on which software protected by means of the present invention may be executed;

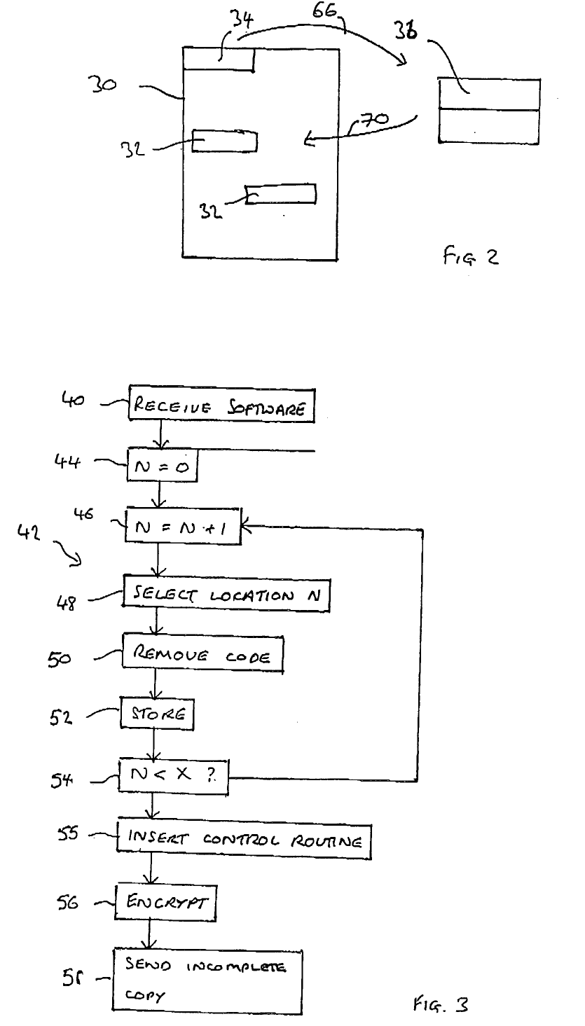

FIG. 2 schematically indicates the contents of RAM of the machine of FIG. 1 during use, and the location of additional code required for execution of protected software;

FIG. 3 is a simplified flow diagram of a method for protecting software in accordance with the invention;

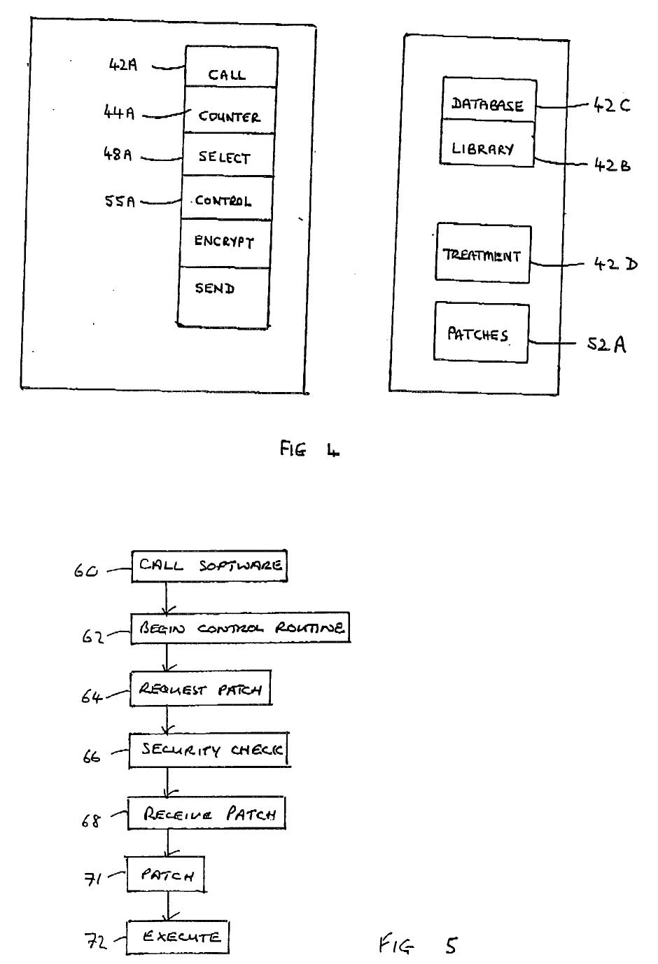

FIG. 4 is a simplified diagram of software and data modules in memory of a machine operating to protect software;

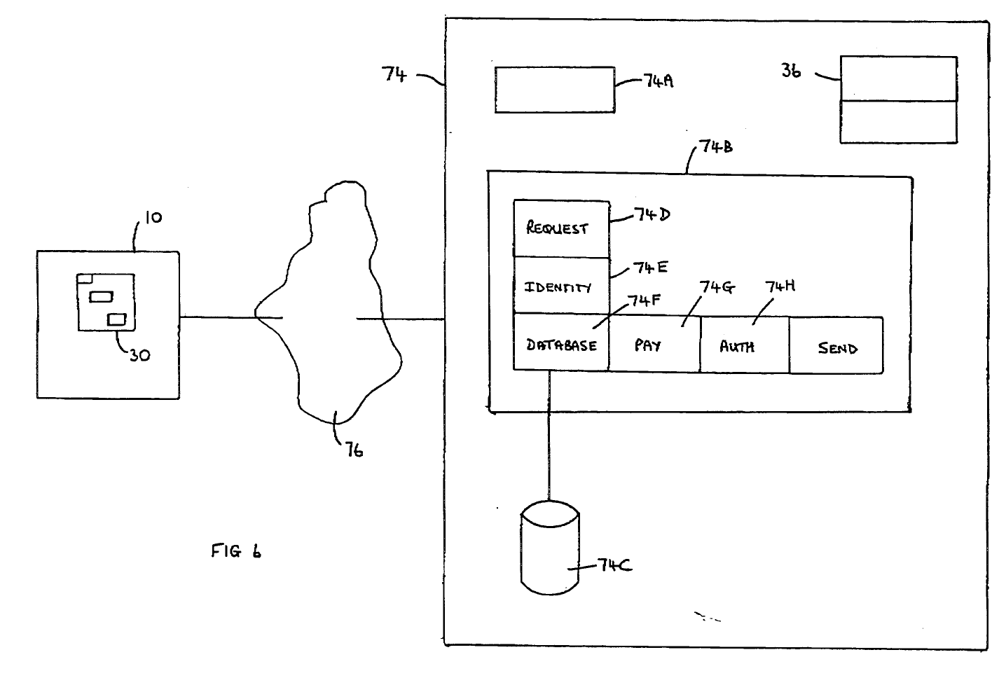

FIG. 5 is a simplified flow diagram of steps required for successful execution of the protected software; and

FIG. 6 is a schematic diagram of an arrangement which requires communication by means of a communication network.

Preferred Hardware Arrangement

FIG. 1 illustrates a general purpose computer 10 by means of which the present invention may be implemented. The computer 10 may be, for example, an IBM compatible personal computer (PC) running under appropriate software control. Alternatively, the computer 10 may be a computer of alternative design, particularly a personal portable computing device of the type used for mobile and wireless access to communication networks, the internet etc.

In FIG. 1, the computer 10 includes a central processor 12 with associated main (RAM) memory 14 and auxiliary memory 16 in the form of a hard disc drive. A display screen and keyboard are provided at 18 and 20, respectively, for use by a user. Other conventional input and output arrangements may be provided at 22, preferably including a device for reading a portable memory medium such as a floppy disc 24, by means of which software and/or data may be loaded into or out of the computer 10. An external communication link 26, such as a connection to the internet or other public or private communication network is also preferably provided.

A skilled reader will have no difficulty in obtaining appropriate hardware and software to form a general purpose computer of the type described above and suitable for implementing the present invention, once the following description of embodiments of the present invention has been fully understood.

In conventional use, software to be executed by the processor 12 is stored in the memory 16 until required. When required, the software is loaded from memory 16 into RAM 14, prior to execution. This is achieved by a software module 16A, commonly called a loader, and shown in memory 16 in FIG. 1. Commonly, the operation of the loader module 16A requires security procedures to be executed by means of a security software module 16B. For example, these may require checks to be made of licence information stored within the computer 10, in order to determine if use of the software is authorised. The licence information may be stored, for example, at 14A, within auxiliary memory, or elsewhere. Conventional checks of this nature can be overridden or circumvented by skilled software writers, often called “hackers”. Once they have successfully circumvented this security, their procedure for doing so is likely to provide a generic approach to circumventing the security attached to any copy of the same software. The software can therefore be copied onto another machine without any licence payments being required in order to make full use of the software.

Overview

FIG. 2 is a schematic diagram which can assist in explaining the basis of one arrangement for implementing the invention. Reference numeral 30 (also shown in FIG. 1) indicates a portion of RAM 14 which is intended to store, during execution, software protected in accordance with the invention. FIG. 2 illustrates the RAM portion 30 after the portion 30 has been loaded from memory 16. Two differences are apparent from the position which would arise when software is loaded from memory 16 to RAM 14 in accordance with conventional arrangements. First, the copy of the software in the RAM portion 30 is incomplete. One or more blocks of code 32 are missing. The choice and location of the missing code 32 will be discussed more fully below. At this point, it is sufficient to note that the RAM portion 30 contains an incomplete copy of the protected software, lacking additional code to be executable.

The second difference is the presence of a control routine at 34. This is illustrated as located at the beginning of the RAM portion 30, in order to execute when the contents of the RAM portion 30 are called. Its function will be described below.

The code which is missing at 32 is located elsewhere, indicated at 36 and may be within or external to the computer 10, as will be described.

The control routine 34 is operable to retrieve the missing code 32 from the location 36 when the protected software is to be executed, and to incorporate or “patch in” the additional code into the protected software at 32, to render the protected software fully executable.

Preparation of Software for Protection

Before discussing the execution of protected software in more detail, it is appropriate to explain the manner in which the software is treated in order to be protected. A simplified set of steps for protecting software is illustrated in FIG. 3. This sequence may be executed by means of an appropriately programmed computer, preferably operated by or on behalf of the proprietor of the software to be protected. FIG. 4 schematically illustrates the software modules and data, relevant to the protection functions, within the machine which is preparing the software for protection.

The sequence begins at 40 by receiving the software to be protected. This is called by a software module 42A which requests the software from a store 42B. The store 42B may be a library of software of the proprietor, maintained by a database software 42C. The software copy retrieved from store 2B is stored temporarily at a treatment location 42D. Thus, a complete copy of the software is made available for treatment. A sequence of events, indicated generally at 42, is then executed, preferably more than once. Consequently, a counter is set at 44 and incremented at 46. These operations are effected by a software module 44A. The first step of the loop 42 is to select a location within the code to be protected. The selection takes place at 48, by means of a software module 48A, and is preferably a random selection of a location within the software. Alternatively, the selection module 48A may select in accordance with a selection algorithm, preferably sufficiently complex to prevent ready prediction of the selection.

The complete copy of the software is then accessed at step 50, from the treatment location 42D, and code is removed from the location selected by the module 48A. The amount of code removed may be the same on each occasion or may be selected as part of the step 48. The code which is removed is temporarily stored (step 52) elsewhere in memory, illustrated as a memory area 52A, labelled PATCHES in FIG. 4. The removed code is deleted from its original location within the area 42D, or replaced with meaningless data.

The counter is checked at step 54 and if appropriate, the counter module 44A causes loop 42 to repeat from step 46 until the loop 42 has been executed a desired number of times. Each time the loop 42 is executed, a new selection is made at 48 and further code is removed at 50 from the software being protected at 42D. On each occasion, this additional code is stored at 52A to build up a block of additional code (“PATCHES”) which is required for reinstating the protected software.

Once the loop 42 has executed the desired number of times, the control routine 34 (FIG. 2) is inserted at step 55 into the protected software by a software module 55A. This completes the formation of the incomplete copy, which will be as shown at 30 in FIG. 2, but stored at 42D.

The incomplete copy may be additionally encrypted at 56 by a software module 56A, for example to provide protection during downloading over a network.

Finally, the incomplete copy of the protected software is sent at 58 to the user, by means of a software module 58A arranged to control the appropriate communication arrangements. This may be achieved by recording the incomplete copy on a carrier medium such as a magnetic or optical memory device, or by transmitting a signal over a carrier medium such as the internet or a wireless communication network.

When the incomplete copy is received by a user machine of the type illustrated in FIG. 1, the incomplete copy will be stored in memory 16 until required. When the software is required, only the incomplete copy is immediately available and is therefore loaded to RAM 14 as has been described above, resulting in the contents of the RAM 14 being as shown at 30 in FIG. 2.

When execution is handed to the incomplete copy at 30, the control routine 34 will initially execute by virtue of its location at the beginning of the portion 30. Alternatively, the control routine 34 may be located elsewhere, with a call command being located at the beginning of the portion 30. Alternatively, the control routine 34 or the call to it may be located after other security routines in the portion 30, such as conventional routines of the type which are vulnerable in the manner described above.

Restoring and Running the Protected Software

The sequence of operation once the software has been called can be described more fully with reference to FIG. 5.

Initially, the software is called at 60, in the usual way. The control routine 34 therefore begins to execute at 62, as has been described. The primary purpose of the control routine 34 is to identify the location of the additional code removed from the software in accordance with the process of FIG. 3, and to send a request at 64 for the additional code to be provided. This request is illustrated by the arrow 66 in FIG. 2, from the control routine to the location 36 of the additional code.

Security checks are preferably made at 68, by the recipient of the request 66. Consequently, the request 66 may incorporate data in addition to data identifying the additional code required, such as details about the machine on which the software is to run, or the user, or the like. Further details of possible security checks are set out below.

Once the checks at 68 have been successfully completed, the additional code is returned, as illustrated by the arrow 70 in FIG. 2 and the control routine 34 patches the additional code at 71 into the RAM 14 to fill the voids at 32 and thus render the protected software complete once again, and thus executable.

The control routine 34 then concludes by handing on execution at 72 to the protected software, which is now complete and executable.

Security Checks and Financial Transactions

The location of the additional code, prior to retrieval, has been described in relation to FIG. 2 as simply “elsewhere”. The additional code may be contained within the same computer 10 but at a memory location outside the portion 30 allocated to the protected software. For example, the additional code may be in an area of memory 14, as shown in FIG. 1. Alternatively, the additional code at 36 may be in the form of a separate process which can be called by the control routine 34 to be loaded into the memory 16 and executed to provide and incorporate the additional code into the locations 32. In this example, the process at 36 can include security checks. For example, licence details can be checked. These security check routines may, in themselves, be similar to conventional security check routines. However, they are less vulnerable to attack because they are not located within the protected software itself. Thus, they will be more difficult for a hacker to locate. Moreover, their location may be different in different machines, or when associated with different protected copies of the same software.

Stronger protection can be achieved with the arrangement illustrated in FIG. 6, which also allows for financial transactions to be implemented. In FIG. 6, the additional code at 36 is not located within the computer 10 which will be executing the protected software, but in another machine, such as a server 74 to which the computer 10 is connected by means of a communication network 76. The network 76 may be a private or public network, such as the internet, and may be a wireless communication network such as a mobile telephone network. Requests (64 in FIG. 4) are sent across the network to the machine 74 to request the additional code 36.

The server 74 is shown in highly simplified form in FIG. 6. A processor 74A is controlled by software in memory 74B and which has access to data at 74C, as will be described, and to the additional code stored at 36.

The server 74 is preferably operable to respond to a request, generally as has been described in relation to FIG. 4. However, before authorising code to be retrieved, the server 74 preferably checks security and financial issues, as follows.

First, a software module 74D detects the receipt of a request and calls a software module 74E to analyse the request to determine the identity of the machine 10 or the user, or other licence details. These are checked by means of a database software module 74F which consults the data 74C containing details of all legitimate requests.

In addition, the server 74 may have access to financial information or facilities by means of a software module 74G. For example, the module 74G may operate to check that the necessary licence fee for using the protected software has been paid by the user from whom the retrieval request has been received, or to implement a payment if not, such as by debiting a credit card account.

Consequently, it is envisaged that use of the protected software could be authorised in return for a single payment, the making of which is checked on each occasion that the software is to be run. Alternatively, a payment could provide access to the software for a fixed period of time, on a subscription basis, or be required on each occasion the software is to be used, so that the checks at 78 and 80 can ensure that the agreed revenue for the software supplier has been recovered.

Successful completion of the checks is determined by an authorisation software module 74H. Once these checks have been completed, the module 74H authorises additional code to be sent to the machine 10, over the network 76, by a software module 74I. The code is then patched into the incomplete copy of the protected software already at the recipient machine, as has been described. The result is a fully functioning copy of the software which can only be constructed if the checks made by the server 74 are successfully completed.

Advantages

The security provided by the systems described above has several aspects. First, the protected software is not provided to the user in complete, executable form. The additional code must be obtained and patched into the incomplete form, before the software is executable. Thus, appropriate security and/or financial steps built into the process of retrieval of the additional code allow the software supplier to ensure that unauthorised use of the software is not occurring.

The code removed from the software when it is being protected can be of arbitrary length and location, not readily identifiable as self-contained so that they are blocks of code, and can be removed from locations which do not themselves form any regular pattern. Consequently, a hacker who wishes to circumvent the protection provided by the invention must first identify the locations from which code has been removed. This is likely to be difficult in itself, in view of the complex nature of modern software and in particular, the normal occurrence of regions of meaningless or blank code within such software, arising from inefficiency in compilers. These normally occurring regions may be numerous, and indistinguishable from the regions created by the removal of code in accordance with the invention. Even if the hacker can successfully identify the locations, the removed content must then be identified or located, and replaced.

A further and significant strength to the arrangements arises from the process of protecting the software and in particular, the presence of the selection step 48. Even if a hacker has been able to successfully analyse a single protected copy of software in order to circumvent the protection provided by the invention, a routine written to circumvent the protection applied to other copies of the same software, by means of the same process, cannot be expected to function on every occasion. In particular, the routine cannot be expected to be generic to all protected copies of the same software. This arises because of the selection step 48, which can be configured to make a different selection, preferably at random, on each occasion, so that the selection of code removed from one protected copy will differ from the selection of code removed from an alternative protected copy of the same software. Thus, an attempt at a generic routine to patch in a particular selection of code into a particular selection of locations would be likely to further corrupt any incomplete copy of the protected software, other than the copy from which the routine was derived.

The complete (i.e. fully executable) copy of the protected software is present only transiently in the RAM, after the retrieval of the additional code. When execution of the protected code ceases, the copy in RAM is lost. This leaves only the incomplete copy in the memory 16. When the protected software is next called for execution, the incomplete copy will again be loaded from memory 16. Thus, the retrieval process must be implemented again, before the copy of the software can be rendered complete and executable. The retrieval process is therefore implemented every time the protected software is executed, because the copy of the software installed in the memory 16 remains incomplete, even after the software has successfully executed.

The incomplete copy of the software, as originally supplied to the user, or the additional code (especially if that is transmitted from another machine), or both, may be further protected by means of arrangements as described in our co-pending International patent application number WO 02/06925.

Alternatives

It will be apparent from the above description that arrangements to implement the present invention can be implemented in many different choices of hardware and software, without affecting the principles underlying the invention.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of protecting computer software against unauthorised use, in which a user machine is provided with an incomplete copy of the software, the incomplete copy lacking additional code to be executable, there being control means operable to retrieve the additional code when the protected software is to be executed, and to incorporate the additional code into the protected software to render the protected software executable.

2. A method according to claim 1, wherein the incomplete copy and the additional code are provided by operating on a complete copy of the software to remove a portion of the code contained therein, the removed portion forming the additional code.

3. A method according to claim 2, wherein one or more locations within the complete copy are selected on each occasion that a copy of the software is to be protected, the additional code being removed from the selected location or locations.

4. A method according to claim 3, wherein the selection of the or a location is made in accordance with a selection algorithm.

5. A method according to claim 3, wherein the selection is substantially random.

6. A method according to claim 1, wherein the control means is incorporated into the incomplete copy to be operable when the protected software is to be executed.

7. A method according to claim 1, wherein the incomplete copy is stored in auxiliary memory of a machine on which the protected software is to be executed, and is loaded to main memory on each occasion the protected software is to be executed, the additional code being retrieved on each occasion.

8. A method according to claim 1, wherein the additional code is incorporated into a process operable to execute, when called by the control means, to reinstate the additional code in the incomplete copy.

9. A method according to claim 8, wherein the process is executable on the same machine on which the protected software is to be executed.

10. A method according to claim 1, wherein the additional code is stored, prior to retrieval, on a machine other than the machine on which the protected software is to be executed, there being a communication link available between the machines, for transmission of the additional code.

11. A method according to claim 10, wherein the communication link is provided by a wireless mobile communication network.

12. A method according to claim 1, wherein retrieval of the additional code is prevented unless authorised.

13. A method according to claim 12, wherein authorisation means is operable to determine if the retrieval is authorised.

14. A method according to claim 13, wherein the authorisation means is operable to effect a financial transaction required for authorisation to be given, or to ascertain whether or not the transaction has been effected.

15. A method according to claim 13, wherein the authorisation means is incorporated within the control means.

16. An incomplete software copy, and additional code, the copy and the code together forming software protected in accordance with the method according to claim 1.

17. An arrangement operable to protect computer software against unauthorised use, and including an incomplete copy of the software for provision to a user machine, the incomplete copy lacking additional code to be executable, and control means operable to retrieve the additional code when the protected software is to be executed, and to incorporate the additional code into the protected software to render the protected software executable.

18. An arrangement according to claim 17, wherein the control means is incorporated into the incomplete copy to be operable when the protected software is to be executed.

19. An arrangement according to claim 17, further comprising a process operable to execute, when called by the control means, to reinstate the additional code in the incomplete copy.

20. An arrangement according to claim 19, wherein the process is executable on the same machine on which the protected software is to be executed.

21. An arrangement according to claim 17, wherein the arrangement includes a machine other than the machine on which the protected software is to be executed, there being a communication link available between the machines, for transmission of the additional code.

22. An arrangement according to claim 21, wherein the communication link is provided by a wireless mobile communication network.

23. An arrangement according to claim 21, wherein the other machine is operable to prevent retrieval of the additional code unless authorised.

24. An arrangement according to claim 23, wherein authorisation means is operable to determine if the retrieval is authorised.

25. An arrangement according to claim 24, wherein the authorisation means is operable to effect a financial transaction required for authorisation to be given, or to ascertain whether or not the transaction has been effected.

26. An arrangement according to claim 24, wherein the authorisation means is incorporated within the other machine.

27. Computer apparatus operable to provide an arrangement as defined in claim 17.

28. Computer software which, when installed on a computer system, is operable to provide a software protection arrangement as defined in claim 17.

29. A carrier medium carrying computer software according to claim 28.

30. A carrier medium according to claim 29, wherein the medium is a memory device.

31. A carrier medium according to claim 29, wherein the medium is a transmission medium, the software being carried by a signal propagating on the transmission medium.

32. A signal propagating on a transmission medium, the signal carrying additional code for use in an arrangement as defined in claim 17.

33. A method of protecting computer software against unauthorised use, in which an incomplete copy of the software is provided, the incomplete copy lacking additional code to be executable, and additional code is provided for retrieval when the protected software is to be executed, the additional code being incorporated into the protected software to render the protected software executable.

34. A method according to claim 33, wherein the incomplete copy and the additional code are provided by operating on a complete copy of the software to remove a portion of the code contained therein, the removed portion forming the additional code.

35. A method according to claim 34, wherein one or more locations within the complete copy are selected on each occasion that a copy of the software is to be protected, the additional code being removed from the selected location or locations.

36. A method according to claim 35, wherein the selection of the or a location is made in accordance with a selection algorithm.

37. A method according to claim 35, wherein the selection is substantially random.

38. A method according to claim 33, wherein control means operable to retrieve the additional code is incorporated into the incomplete copy to be operable when the protected software is to be executed.

39. A method according to claim 38, wherein the additional code is incorporated into a process operable to execute, when called by the control means, to reinstate the additional code in the incomplete copy.

40. A method according to claim 39, wherein the process is executable on the same machine on which the protected software is to be executed.

41. A method according to claim 38, wherein the additional code is stored, prior to retrieval, on a machine other than the machine on which the protected software is to be executed, there being a communication link available between the machines, for transmission of the additional code.

42. A method according to claim 41, wherein the communication link is provided by a wireless mobile communication network.

43. A method according to claim 33, wherein retrieval of the additional code is prevented unless authorised.

44. A method according to claim 43, wherein authorisation means is operable to determine if the retrieval is authorised.

45. A method according to claim 44, wherein the authorisation is operable to effect a financial transaction required for authorisation to be given, or to ascertain whether or not the transaction has been effected.

46. A method according to claim 44, wherein the authorisation means is incorporated within the control means.

47. An arrangement for protecting computer software against unauthorised use, the arrangement including first means operable to provide an incomplete copy of the software, the incomplete copy lacking additional code to be executable, and there being control means operable to retrieve the additional code when the protected software is to be executed, and to incorporate the additional code into the protected software to render the protected software executable.

48. An arrangement according to claim 47, wherein the first means is operable on a complete copy of the software to remove a portion of the code contained therein, the removed portion forming the additional code.

49. An arrangement according to claim 47, wherein the first means selects one or more locations within the complete copy on each occasion that a copy of the software is to be protected, the additional code being removed from the selected location or locations.

50. An arrangement according to claim 49, wherein the selection of the or a location is made in accordance with a selection algorithm.

51. An arrangement according to claim 49, wherein the selection is substantially random.

52. An arrangement according to claim 47, wherein the control means is incorporated into the incomplete copy to be operable when the protected software is to be executed.

53. An arrangement according to claim 47, wherein the additional code is incorporated into a process operable to execute, when called by the control means, to reinstate the additional code in the incomplete copy.

54. An arrangement according to claim 53, wherein the process is executable on the same machine on which the protected software is to be executed.

55. An arrangement according to claim 47, further including a machine other than the machine on which the protected software is to be executed, and on which the additional code may be stored, prior to retrieval, there being a communication link available between the machines, for transmission of the additional code.

56. An arrangement according to claim 55, wherein the communication link is provided by a wireless mobile communication network.

57. An arrangement according to claim 55, wherein said other machine prevents retrieval of the additional code unless authorised.

58. An arrangement according to claim 57, wherein the authorisation means is operable to determine if the retrieval is authorised.

59. An arrangement according to claim 58, wherein the authorisation means is operable to effect a financial transaction required for authorisation to be given, or to ascertain whether or not the transaction has been effected.

60. A method of providing computer software for a user, in which a user machine is provided with an incomplete copy of the software, the incomplete copy lacking additional code to be executable, and the additional code is made available for retrieval when the protected software is to be executed and an authorisation procedure has been completed, the additional code being incorporated into the protected software to render the protected software executable.

61. A method according to claim 60, wherein the additional code is stored, prior to retrieval, on a machine other than the machine on which the protected software is to be executed, there being a communication link available between the machines, for transmission of the additional code.

62. A method according to claim 61, wherein the communication link is provided by a wireless mobile communication network.

63. A method according to claim 61, wherein authorisation means is operable to determine if the retrieval is authorised.

64. A method according to claim 63, wherein the authorisation is operable to effect a financial transaction required for authorisation to be given, or to ascertain whether or not the transaction has been effected.

65. A method according to claim 64, wherein the authorisation means is incorporated within the control means.
